(19) United States
(12) Patent Application Publication
(10) Pub. No.: US 2004/0246982 A1
(43) Pub. Date: Dec. 9, 2004

(54) Methods and apparatus for configuring a packet switching (PS) backplane to support various configurations

(75) Inventors: Ramani Krishnamurthy, Fremont, CA (US); Raymond K. Ho, San Jose, CA (US); Balkar S. Sidhu, San Jose, CA (US)

Correspondence Address: B. Noel Kivlin, Myertons. Hood, Kivlin, Kowart & Goetzel. P.C., P.O. Box 398, Austin, TX, 78767-0398, US

(73) Assignee: SUN MICROSYSTEMS, INC.

(21) Appl. No.: 10/455,938

(22) Filed: Jun. 6, 2003

(51) Int. Cl. H04L 12/56

(52) U.S. Cl. 370/422

(57) ABSTRACT

A method and system is adapted to provide for a low-cost and highly flexible system that can control and change configurations on one or more segments of a Compact Peripheral Component Interconnect Packet Switching Backplane (CPCI/PSB or CPCI and CPSB) during the backplane's lifetime that overcomes the limitations of the prior art. In one embodiment of the present invention, the segments are configurable to either a CPCI and CPSB configuration or a CPSB only configuration by controlling a CPCI indication signal, such as a PCI_PRESENT# signal. The PCI_PRESENT# signal of the present invention is to be controlled by a Chassis Management Controller (CMC) and the CMC software is used to configure each of the segments by driving zero or one on the segments (instead of hardwiring these segments to ground or open during the manufacturing of the backplane). This embodiment allows for the flexibility to configure each of the segments to either a CPCI and CPSB configuration or a CPSB only configuration and provides the flexibility to support CPCI and CPSB front cards (or interface boards) in a host-less (e.g., CPSB only) environment and/or host (e.g., CPCI and CPSB) environment.

### BACKGROUND OF THE INVENTION

1. Field of the Invention

The present invention relates to a Compact Peripheral Component Interconnect (CPCI) system. More particularly, the present invention relates to methods and apparatus that are adapted for configuring a Compact Peripheral Component Interconnect Packet Switching Backplane (CPCI/PSB) to support various configurations.

2. Description of Related Art

Compact Peripheral Component Interconnect (CPCI) is a high performance industrial bus based on the standard PCI electrical specification in rugged 3U or 6U Eurocard packaging. CPCI is intended for application in telecommunications, computer telephony, real-time machine control, industrial automation, real-time data acquisition, instrumentation, military systems or any other application requiring high speed computing, modular and robust packaging design, and long-term manufacturer support. Because of its high speed and bandwidth, the CPCI bus is particularly well suited for many high-speed data communication applications such as servers, routers, and switches.

Compared to a standard desktop PCI, CPCI supports many more PCI slots and offers an ideal packaging scheme for industrial applications. Conventional CPCI cards are designed for front loading and removal from a card cage. The cards are firmly held in position by their connector, card guides on both sides, and a faceplate that solidly screws into the card cage. Cards are mounted vertically allowing for natural or forced air convection for cooling. Also, the pin-and-socket connector of the CPCI card is significantly more reliable and has better shock and vibration characteristics than the card edge connector of the standard PCI cards.

Conventional CPCI defines a CPCI backplane that is typically limited to eight slots. More specifically, the bus segment of the conventional CPCI system is limited to eight slots, which includes a system slot and peripheral slots. A host central processing unit (CPU) card (or a host card) occupies the system slot and provides the clocking, arbitration, configuration, and interrupt processing for up to seven peripheral slots. The peripheral slots can be populated with input/output (I/O) cards or satellite CPU cards.

The newest trend in the CPCI systems is to provide a packet-based switching architecture to the CPCI systems. The CPCI Packet Switching Backplane (CPCI/PSB) is an extension to the CPCI system that overlays a packet-based switching architecture on top of the CPCI system to create an Embedded System Area Network (ESAN). This extended CPCI system (e.g., a CPCI/PCB system or a CPCI and CPSB system) supplements the robust, reliable and hot-swap capable CPCI architecture with the easily integrated, low-cost, high-performance, and extensible Ethernet (e.g., a CPCI/PSB supports even more PCI slots than the conventional CPCI backplane). This extended backplane (i.e., CPCI/PSB) creates a platform that is well suited to the integration of components for the most demanding systems and empowers system integration and design to ascend to higher layers of the Open Systems Interconnection (OSI) protocol stack, thus reducing system integration time.

In a CPCI/PSB embodiment, the backplane can include one or more segments (or groups of card slots). Like a conventional CPCI backplane, a segment of a CPCI/PSB requires that a host card be included in the segment. The host card is needed to provide the clocking (PCI_Clock or PCI_CLK) and other PCI signals to the other cards in the segment. However, problems arise when a host-less configuration (e.g., a PS-only backplane or PSB only) is desired by a user because the PCI interface on the backplane will be floating and this will damage the cards on the backplane (e.g., the CMOS device on the card). Accordingly, it would be desirable to provide a CPCI/PSB system that is adapted to allow for a host-less configuration on at least one of its segments. In addition, it would be desirable for such a system to provide for a host-less configuration on one segment and a host configuration on another segment of the CPCI/PSB. It would further be desirable to provide such a system with an ability to change the configurations of the one or more segments on the backplane (i.e., the CPCI/CPS) in a cost-effective manner throughout the lifetime of the backplane (e.g., without having to modify the backplane's hardware which can become quite costly).

### SUMMARY OF THE INVENTION

The present invention relates to a Compact Peripheral Component Interconnect Packet Switching Backplane (CPCI/PSB) system that is adapted to provide for a low-cost and highly flexible system that can be reconfigured during the system's lifetime to overcome the limitations of the prior art. The system allows the backplane of the CPCI/PSB system to variably change configuration to a segment on the backplane without requiring any modification of the backplane's hardware.

In an embodiment of the present invention, a plurality of segments are configurable to either a Compact Peripheral Component Interconnect (CPCI) and Compact Pocket Switching Backplane (CPSB) configuration or a CPSB only configuration by controlling a CPCI indication signal, such as a PCI_PRESENT# signal. The PCI_PRESENT# signal of the present invention is to be controlled by a Chassis Management Controller (CMC) and the CMC software is used to configure each of the segments by driving zero or one on the segments (instead of hardwiring these segments to ground or open during the manufacturing of the backplane). This embodiment allows for the flexibility to configure each of the segments to either a CPCI and CPSB configuration or a CPSB only configuration and provides the flexibility to support CPCI and CPSB front cards (or interface boards) in a host-less (e.g., CPSB only) and/or host (e.g., CPCI and CPSB) environments.

In another embodiment of the invention, a CPCI/PSB system includes a chassis, a circuit board forming a backplane within said chassis, and a plurality of segments on the circuit board. Each of the segments includes a plurality of slots for coupling to a plurality of front cards. A CMC is coupled with the circuit board and a CMC software running on the CMC. The CMC is wired to a plurality of communication links. Each of the communication links is coupled to a corresponding one of the segments. The CMC software running on the CMC can be used to assert either a first CPCI signal or a second CPCI signal to each of the segments via the communication links. The first CPCI signal configures a segment as a CPCI/PSB segment and the second signal configures a segment as a CPSB only segment.

In a further embodiment of the invention, a method is developed for implementing configurations on a CPCI/PSB. The method includes the following steps. A CMC is coupled to a plurality of segments on the CPCI/PSB through a plurality of communication links. A CMC software running on said CMC checks an input that is user configurable. If the input indicates a CPCI/PSB configuration, the CMC software asserts a logical zero reset signal, a logical zero clock signal, and a ground indication signal to one of the segments. If the input indicates a CPSB only configuration, the CMC software asserts a host card reset signal, a host card clock signal, and an open indication signal to one of the segments. The CMC software then checks whether all of the segments on the CPCI/PSB have been configured. If all the segments have been configured, the method proceeds to power on a plurality of front cards on the CPCI/PSB.

In yet another embodiment, a CPCI/PSB system is used to variably support a CPCI legacy card, a CPCI/PSB card configured to require a host card, and a CPCI/PSB card configured to operate without a host. The system includes a chassis, a power supply unit (PSU), and a circuit board forming a backplane within the chassis. The backplane includes first and second segments. Each of the segments includes a plurality of slots for coupling to a plurality of front cards. A CMC is coupled with the backplane and a CMC software running on the CMC. The CMC includes first, second, and third independent communication links. The first independent communication link is coupled to the first segment. The second independent communication link is coupled to the second segment. The third independent communication link is coupled to the PSU. The CMC software asserts a first configuration signal or a second configuration signal to the first and second segments via the first and second communication links.

A more complete understanding of the present invention will be afforded to those skilled in the art, as well as a realization of additional advantages and objects thereof, by a consideration of the following detailed description of the embodiment. Reference will be made to the appended sheets of drawings, which first will be described briefly.

### BRIEF DESCRIPTION OF THE DRAWINGS

The drawings illustrate the design and utility of preferred embodiments of the invention. The components in the drawings are not necessarily to scale, emphasis instead being placed upon illustrating the principles underlying the embodiment. Moreover, in the drawings like-reference numerals designate corresponding parts throughout the different views.

FIG. 1 is an exploded perspective view of a Compact Peripheral Component Interconnect (CPCI) chassis system according to an embodiment of the invention;

FIG. 2 shows the form factors that are defined for the CPCI front card;

FIG. 3 is a front view of a backplane having eight slots with five connectors each;

FIG. 4(a) shows a front view of another CPCI backplane;

FIG. 4(b) shows a back view of the backplane of FIG. 4(a);

FIG. 5 shows a side view of the backplane of FIGS. 4(a) and 4(b);

FIG. 6(a) shows a front view of a pin out arrangement of the connectors of a slot;

FIG. 6(b) shows a back view of the pin out arrangement of the connectors of the slot of FIG. 6(a);

FIG. 7 shows a hot swappable CPCI system for detecting the presence of a hot swappable front card;

FIG. 8 is a block diagram of a CPCI and Compact Packet Switching Backplane (CPSB) chassis system according to an embodiment of the invention;

FIG. 9 is a block diagram of a CPCI and CPSB only chassis system that is fixed by hardware;

FIG. 10 is a block diagram of a CPSB only chassis system that is fixed by hardware;

FIG. 11 is a block diagram of a CPCI and CPSB chassis system that is configured by software according to another embodiment of the present invention; and

FIG. 12 is a flow diagram showing exemplary steps of a method according to the invention.

### DETAILED DESCRIPTION

The present invention is directed to a method and system that is adapted to provide for a low-cost and highly flexible system that can control and change configurations on one or more segments of a Compact Peripheral Component Interconnect Packet Switching Backplane (CPCI/PSB or CPCI and CPSB) during the backplane's lifetime that overcomes the limitations of the prior art. In one embodiment of the present invention, the segments are configurable to either a Compact Peripheral Component Interconnect (CPCI) and Compact Packet Switching Backplane (CPSB) configuration or a CPSB only configuration by controlling a CPCI indication signal, such as a PCI_PRESENT# signal. The PCI_PRESENT# signal of the present invention is to be controlled by a Chassis Management Controller (CMC) and the CMC software is used to configure each of the segments by driving zero or one on the segments (instead of hardwiring these segments to ground or open during the manufacturing of the backplane). This embodiment allows for the flexibility to configure each of the segments to either a CPCI and CPSB configuration or a CPSB only configuration and provides the flexibility to support CPCI and CPSB front cards (or interface boards) in a host-less (e.g., CPSB only) environment and/or a host (e.g., CPCI and CPSB) environment.

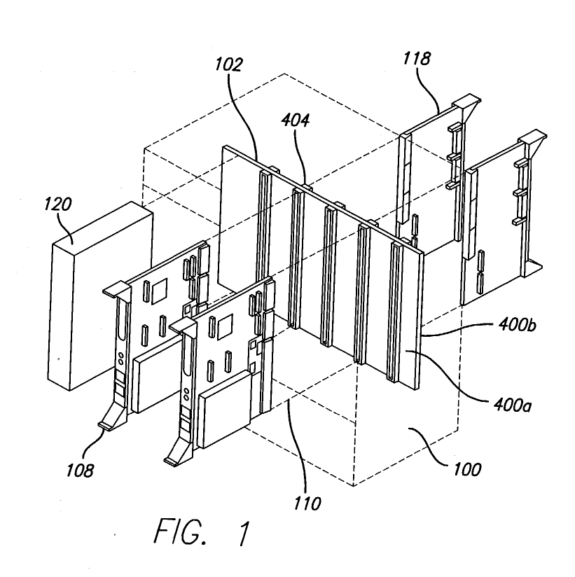

Referring to FIG. 1, there is shown an exploded perspective view of a CPCI chassis system as envisioned in an embodiment of the present invention. The chassis system 100 includes a CPCI circuit board referred to in the conventional CPCI system as a passive backplane (or midplane) 102 since the circuit board is located at the back of the chassis 100 and front cards (e.g., host and/or daughter cards) are inserted from the front of the chassis 100. The front side 400a of the backplane 102 has slots provided with connectors 404. A corresponding transition card 118 may be coupled to the front card 108 via backplane 102. The backplane 102 may also contain corresponding slots and connectors (not shown) on its backside 400b to mate with transition card 118. In the chassis system 100 that is shown, a front card 108 may be inserted into appropriate slots and mated with the connectors 404. For proper insertion of the front card 108 into the slot, card guides 110 are provided. This CPCI chassis system 100 provides front removable front cards and unobstructed cooling across the entire set of front cards.

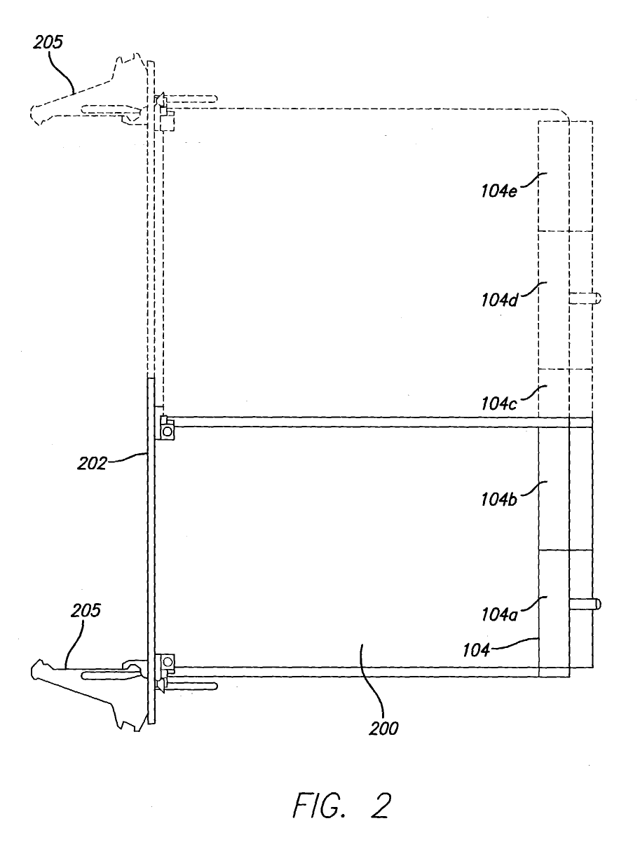

Referring to FIG. 2, there are shown the form factors defined for the CPCI front card (e.g., motherboard), which is based on the PICMG CPCI industry standard (e.g., the standard in the PICMG 2.0 CPCI specification). As shown in FIG. 2, the front card 200 has a front plate interface 202 and ejector/injector handles 205. The front plate interface 202 is consistent with PICMG CPCI packaging and is compliant with IEEE 1101.1 or IEEE 1101.10. The ejector/injector handles should also be compliant with IEEE 1101.1. Two ejector/injector handles 205 are used for the 6U front cards in the present invention. The connectors 104a-104e of the front card 200 are numbered starting from the bottom connector 104a, and the 6U front card size is defined, as described below.

The dimensions of the 3U form factor are approximately 160.00 mm by approximately 100.00 mm, and the dimensions of the 6U form factor are approximately 160.00 mm by approximately 233.35 mm. The 3U form factor includes two 2 mm connectors 104a-104b and is the minimum as it accommodates the full 64-bit CPCI bus. Specifically, the 104a connectors are reserved to carry the signals required to support the 32-bit PCI bus; hence no other signals may be carried in any of the pins of this connector. Optionally, the 104a connectors may have a reserved key area that can be provided with a connector “key,” which may be a pluggable piece (e.g., a pluggable plastic piece) that comes in different shapes and sizes, to restrict the add-on card to mate with an appropriately keyed slot. The 104b connectors are defined to facilitate 64-bit transfers or for rear panel I/O in the 3U form factor. The 104c-104e connectors are available for 6U systems as also shown in FIG. 2. The 6U form factor includes the two connectors 104a-104b of the 3U form factor, and three additional 2 mm connectors 104c-104e. In other words, the 3U form factor includes connectors 104a-104b, and the 6U form factor includes connectors 104a-104e. The three additional connectors 104c-104e of the 6U form factor can be used for secondary buses (i.e., Signal Computing System Architecture (SCSA) or MultiVendor Integration Protocol (MVIP) telephony buses), bridges to other buses (i.e., Virtual Machine Environment (VME) or Small Computer System Interface (SCSI)), or for user specific applications. Note that the CPCI specification defines the locations for all of the connectors 104a-104e, but only the signal-pin assignments for certain connectors are defined (e.g., the CPCI bus portion 104a and 104b are defined). The remaining connectors are the subjects of additional specification efforts or can be user defined for specific applications, as described above.

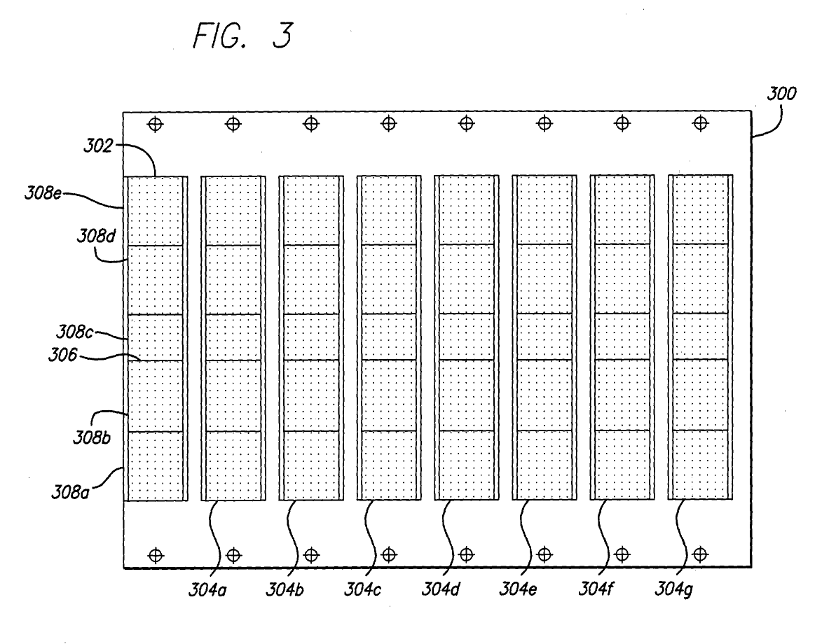

Referring to FIG. 3, there is shown a front view of a 6U backplane having eight slots. A CPCI system includes one or more CPCI bus segments, where each bus segment typically includes up to eight CPCI card slots. Each CPCI bus segment includes at least one system slot 302 and up to seven peripheral slots 304a-304g. The CPCI front card for the system slot 302 provides arbitration, clock distribution, and reset functions for the CPCI peripheral cards on the bus segment. The peripheral slots 304a-304g may contain simple cards, intelligent slaves and/or PCI bus masters.

The connectors 308a-308e have connector-pins 306 that project in a direction perpendicular to the backplane 300, and are designed to mate with the front side “active” cards (“front cards”), and “pass-through” its relevant interconnect signals to mate with the rear side “passive” input/output (I/O) card(s) (“rear transition cards”). In other words, in the conventional CPCI system, the connector-pins 306 allow the interconnected signals to pass-through from the front cards, such as the motherboards, to the rear transition cards.

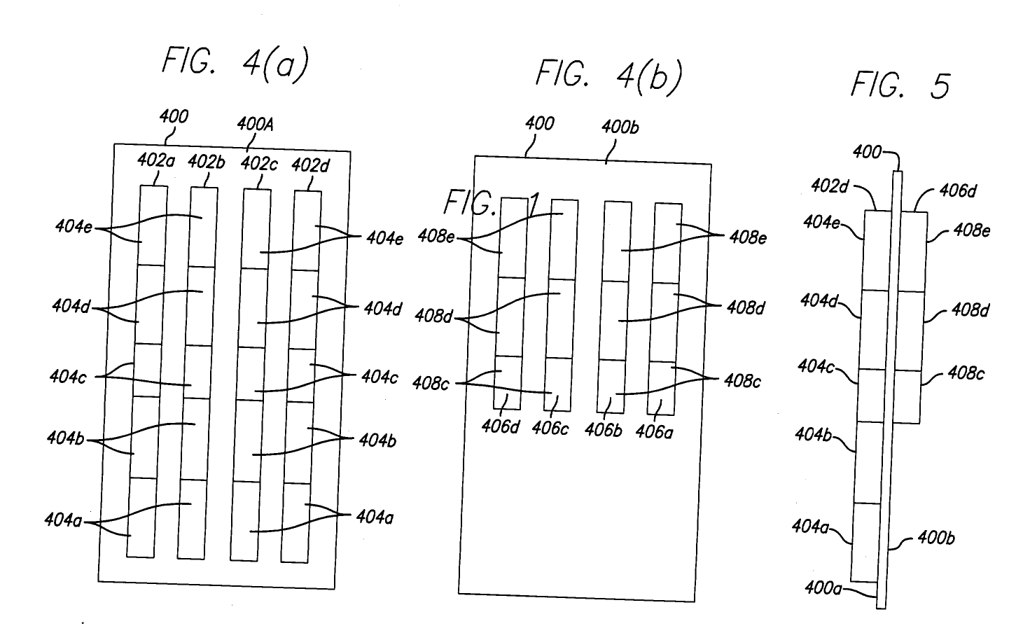

Referring to FIGS. 4(a) and 4(b), there are shown respectively a front and back view of a CPCI backplane in another 6U form factor embodiment. In FIG. 4(a), four slots 402a-402g are provided on the front side 400a of the backplane 400. In FIG. 4(b), four slots 406a-406g are provided on the back side 400b of the backplane 400. Note that in both FIGS. 4(a) and 4(b) four slots are shown instead of eight slots as in FIG. 3. Further, it is important to note that each of the slots 402a-402d on the front side 400a has five connectors 404a-404e while each of the slots 406a-406d on the back side 400b has three connectors 408c-408e. This is because the 404a connectors are provided for 32-bit PCI and connector keying and the 404b connectors are typically only for I/O in the 3U form factor. Thus, in the 6U form factor they do not typically have I/O connectors to their rear. Accordingly, the front cards that are inserted in the front side slots 402a-402d only transmit signals to the rear transition cards that are inserted in the back side slots 406a-406d through front side connectors 404c-404e.

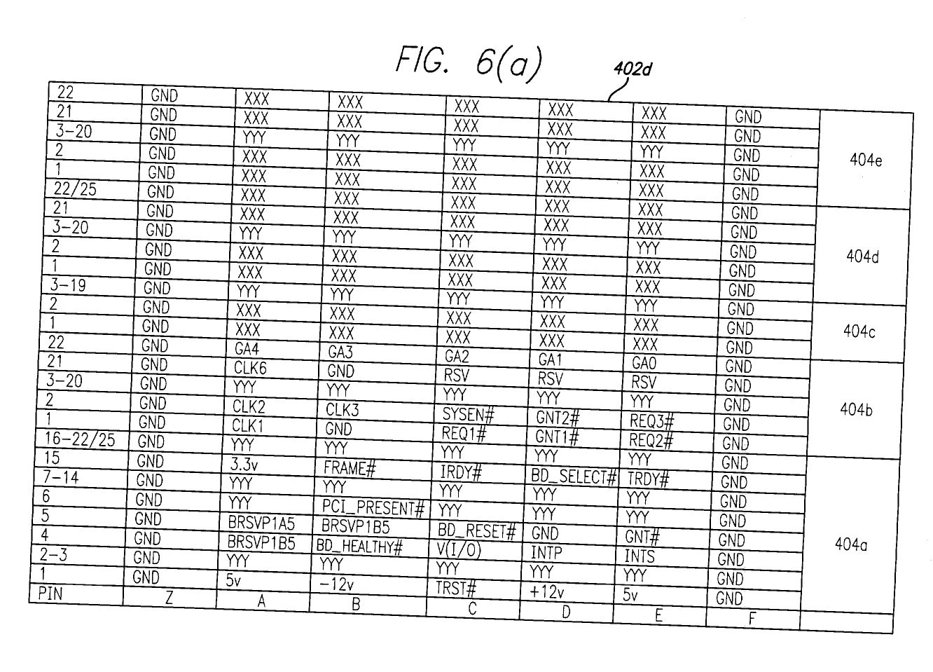

Referring to FIG. 5, there is shown a side view of the backplane of FIGS. 4(a) and 4(b). As shown in FIG. 5, slot 402d on the front side 400a and slot 406d on the back side 400b are arranged to be substantially aligned so as to be back-to-back. Further, slot 402c on the front side 400a and slot 406c on the backside 400b are arranged to be substantially aligned, and so on. Accordingly, the front side connectors 404c-404e are arranged back-to-back with the back side connectors 408c-408e. Note that the front side connector 404a-404b does not have a corresponding back side connector. It is important to note that the system slot 402a is adapted to receive the front card having a CPU; the signals from the system slot 402a are then transmitted to corresponding connector-pins of the peripheral slots 402b-402d. Thus, the preferred CPCI system can have expanded I/O functionality by adding peripheral front cards in the peripheral slots 402b-402d.

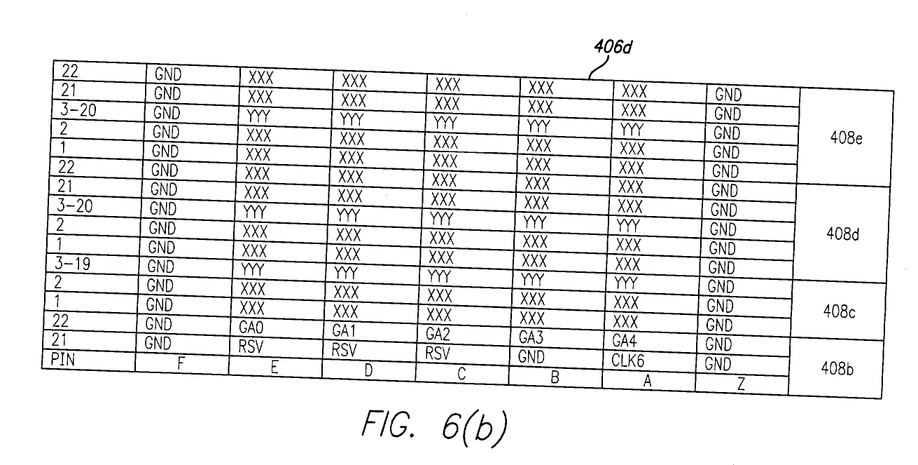

FIGS. 6(a) and 6(b) illustrate a pin out arrangement of the connectors in a CPCI system. Specifically, FIG. 6(a) shows a front view of a conventional pin out arrangement of the connectors of a slot. Referring to FIG. 6(a), there are shown connectors 404a-404e of slot 402d. The connector-pins are arranged in a column and row configuration. Each of the connectors 404a-404e has seven columns of pins, which are designated as Z, A, B, C, D, E, and F going from left to right. Each of the connectors 404a-b and 404d-e also has twenty-two rows of connector-pins. Connector 404c has nineteen rows of connector-pins.

As shown in FIG. 6(a), all of the connector-pins in the Z and F columns are connected to a ground layer GND in the backplane. The connector-pins of the other columns A, B, C, D, and E are connected to various other signals including ground. Note that in FIG. 6(a), the connector-pins having XXX or YYY designations do not mean that those pins share the same signals, respectively. Instead, the XXX or YYY designations are provided to show that these connector-pins are defined to carry various signals, including CPCI signals. Note that connectors 404a-404c carry CPCI signals. Note also that the other slots 402a-402c have a similar pin out arrangement as shown in slot 402d of FIG. 6(a).

FIG. 6(b) shows a back view of a pin out arrangement of the connectors of a slot. Referring to FIG. 6(b), there are shown connectors 408c-408e of slot 406d. Note that the back view shows three connectors instead of five. This is because, as shown in FIGS. 4(a) and 4(b), the front side of the backplane has five connectors while the back side of the backplane has three connectors. Further, the column arrangement of the connector-pins is designated as F, E, D, C, B, A, and Z going from left to right. This is because the connector-pins of slots 402d and 406d are straight-pass through pins, and so the column designations are mirror images with respect to each other. For example, the connector-pin located at column A, row 2 of connector 404c is the same connector-pin located at column A, row 2 of connector 408c. Also, similar to FIG. 6(a), connector-pins located at columns F and Z in FIG. 6(b) are connected to a ground layer GND in the backplane. Likewise, connector-pins of columns A, B, C, D, and E are connected to various signals, as shown in FIG. 6(a).

More specifically, the Hot Swap/HA specification defines the connector-pin located at column D, row 15 of connector 404a to be a BD_SELECT# pin. Other relevant connector-pins of connector 404a include a BD_HEALTHY# pin, which is located at column B, row 4, and a BD_RESET# pin, which is located at column C, row 5. The significance of these connector-pins in the Hot Swap/HA specification is discussed in more detail below.

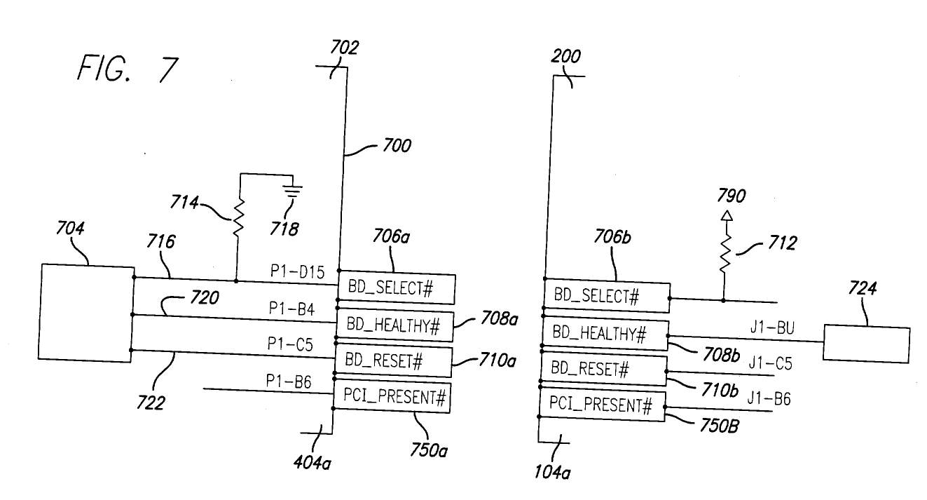

FIG. 7 shows a hot swappable CPCI system for detecting the presence of a hot swappable front card. Referring to FIG. 7, a CPCI backplane 700 has a connector 404a in a slot 702, and a hot swap controller 704 coupled to the backplane 700. The connector 404a has the BD_SELECT# 706a, BD_HEALTHY# 708a, and BD_RESET# 710a connector-pins, which are of male-type, connected to the hot swap controller 704. Note that the BD_-SELECT# line 716 is connected to a “weak-pull-down” resistor 714 that is connected to a ground layer 718 in the backplane 702. A front card 200 has corresponding BD_SELECT# 706b, BD_HEALTHY# 708b, and BD_RESET# 710b connector-pins, which are of female-type, with the BD_SELECT# pin 706b being connected to a power domain (e.g., a voltage source) or more specifically an Early Power Domain 790 through a pull-up resistor 712. The BD_SELECT# line 716 is an input/output line and is defined to provide a signal to the hot swap controller 704 such that the controller 704 knows whether a hot swappable front card has been inserted in a particular slot. Further, the hot swap controller 704 performs the powering up/down of the hot swappable front card using this line 716. The BD_HEALTHY# pin 708b is connected to an internal power supply 724 in the front card 200. Accordingly, the BD_HEALTHY# line 720 is a hot swap controller input line and is used to indicate to the hot swap controller 704 whether or not the board is defective. The BD_RESET# line 722 is an input/output line and is used by the hot swap controller 704 to reset the front card if it is to remain in a backup mode. All of the above described functions of the BD_SELECT#, BD_HEALTHY#, and BD_RESET# lines are described in more detail below.

Specifically, when the hot swappable front card 200 is inserted into a slot of the backplane 702 such that the connectors 404a and 104a mate, the BD_SELECT# pin 706a is pulled up to the voltage level of the BD_SELECT# pin 706b. This pull-up on the BD_SELECT# pin 706a is detected by the hot swap controller 704 such that the hot swap controller 704 senses that a hot swappable front card 200 has been inserted in the particular slot 702. The hot swap controller 704 then drives the BD_SELECT# line 716 low so as to allow the front card to power up. Then, the hot swap controller 704 examines the BD_HEALTHY# line 720 to determine if the inserted front card 200 is healthy. This determination is made by sensing the voltage level from the internal power supply 724. The hot swap controller then drives the BD_RESET# line 722 high to release the front card from the reset mode and to connect to the system, or if the front card is a backup board, then the BD_RESET# line 722 is driven low to maintain the front card 200 in the reset mode until backup is needed from the front card 200.

Embodiments of the present invention are applicable to a CPCI/PSB (or CPCI and CPSB) system. In one embodiment and referring now to FIGS. 6(a) and 7, a BD_PRESENT# or PCI_PRESENT# connector-pin 750a is added for use by the CPSB/PSB system of the present invention at column B, role 6 of connector 404a. The connectors 404a and 404d of the CPCI/PSB system can also each have twenty-five rows (as opposed to only twenty-two rows) of connector-pins. A front card 200 that is to be inserted into the CPCI/PSB (for example card 200 in FIG. 7) has a corresponding PCI_PRESENT# connector-pin 750b. The functions of and the reasons for the PCI_PRESENT# connector-pins and the CPCI/PSB are described in more detail below.

As previously stated, a CPCI/PSB is an extension to the CPCI system that overlays a packet-based switching architecture on top of the CPCI to create an Embedded System Area Network (ESAN). The CPCI/PSB system of the present invention supplements the robust, reliable and hot-swap capable CPCI architecture with the easily integrated, low-cost, high-performance, and extensible Ethernet architecture. For example, in a conventional CPCI system, there is a single CPCI interface on the backplane having only a single point of failure. By contrast, the CPCI/PSB system adds an Ethernet interface that is apart from the CPCI interface. This new (or paddle) Ethernet interface provides for an alternative functional interface (or channel) in case of failure of one of the main interfaces. The Ethernet interface also provides a data transmission speed that can be much higher than the CPCI interface. In addition, the CPCI/PSB system has the option of either implementing or not implementing its CPCI interface (e.g., by using its PCI_PRESENT# signals at column B, role 6 of connector 404a). Moreover, the added Ethernet interface (that is apart from the CPCI interface) provides the CPCI/PSB with the ability to be integrated with even more components than the conventional CPCI backplane.

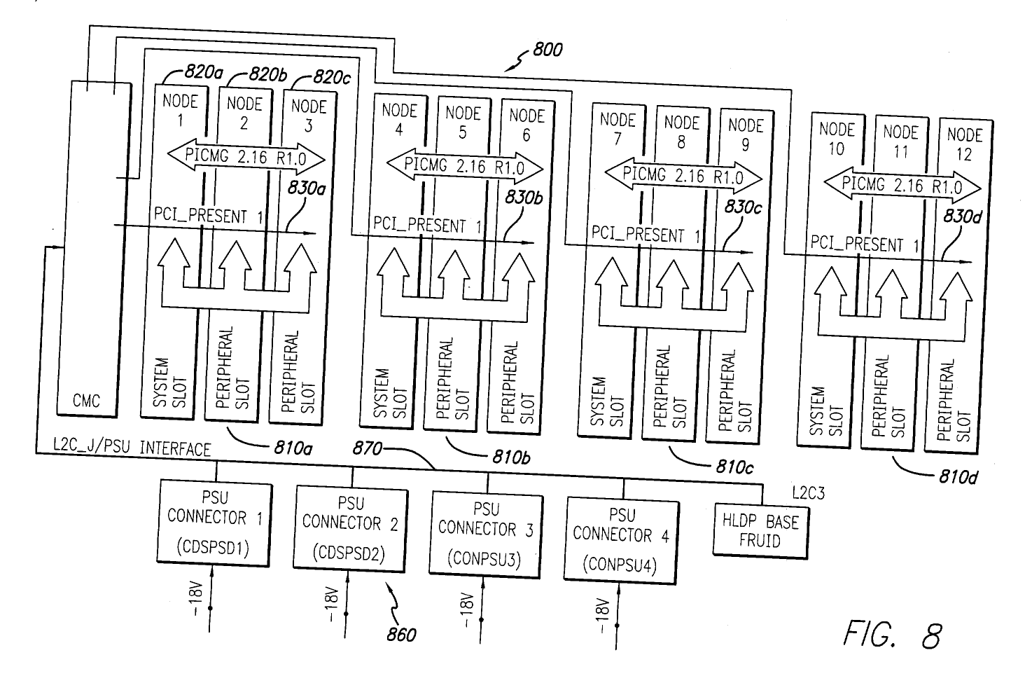

Referring now to FIG. 8, a CPCI/PSB embodiment of the present invention includes a twelve slot backplane (or midplane) 800. The twelve slot backplane 800 provides four segments 810a-810d and three slots 820a-820c per segment 810. Each of the segments 810a-810d electronically can support a CPCI and CPSB front card (not shown) that can be on the backplane 800.

It should be apparent that a CPCI/PSB of the present invention may comprise other numbers of segments and slots in each segments. For example, another CPCI/PSB embodiment of the present invention includes a twenty-one slot backplane (or midplane). The twenty-one slot (or 21-slot) backplane provides six (6) segments and each segment supports the CPCI and CPSB configuration electronically on its backplane. However, as per the PCI Industrial Computer Manufacturers Group (PICMG) standards (e.g., PICMG 2.16 R1.0 specification), each of these segments for supporting a CPCI and CPSB configuration requires a host front card (e.g., in system slot 820a) in each segment and does not, for example, support a CPSB only configuration.

As envisioned in the present invention (and per the PICMG 2.16 R1.0 specification), once a front card is inserted onto a backplane (e.g., 800), it determines whether its corresponding segment (e.g., 810) is a CPCI and CPSB segment or a CPSB only segment based on the state of PCI _PRESENT# signal. PCI_PRESENT# will be tied to ground on the backplane (e.g., 800) if the segment 810 supports the CPCI and CPSB configuration on the segment. In the PICMG 2.16 R1.0 specification, the PCI_PRESENT# is a hardwired indication. That is, a hardwired ground is added to the connection on the backplane that is providing the PCI_PRESENT# to provide a grounded signal. This grounded PCI_PRESENT# signal will indicate to each of the CPCI and CPSB front cards (or interface boards) to expect a PCI_CLOCK and other PCI signals from a host card in its configuration. Thus, supporting CPCI and CPSB interface cards or boards (hereafter referred to as universal cards) in the segment configured to be CPCI and CPSB without a host card is not possible because the PCI interface CMOS clock input will be floating, which will damage the PCI device. Also, the universal card will expect the hotswap handling functions on the card to be performed from the host card since in the CPCI and CPSB system, hotswap handling is handled by the host card. (By contrast, for example in the CPSB only system, the hotswap handling responsibilities lie on individual front (or node) cards.) Accordingly, the universal card in the CPCI and CPSB system expects the host card to perform all the hotswap handling activities. The universal card will malfunction without the host card. Thus, to support universal card in CPCI and CPSB system, the system requires the use of a host card. That is, a universal card cannot be used as a host-less (or CPSB only) card in a CPCI and CPSB configured system.

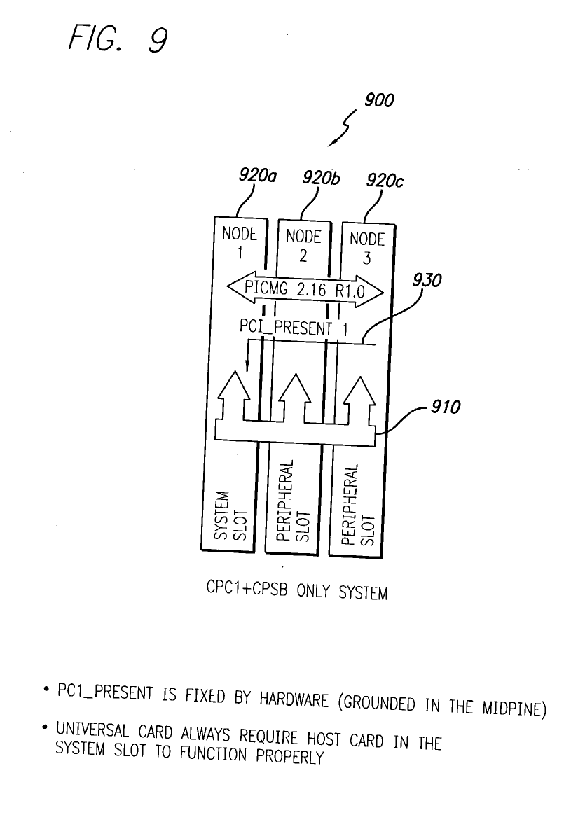

Embodiments of the present invention are applicable to existing CPCI/PSB systems that are compliant with the PICMG 2.0 R3.0 standard, which requires a host card in the system slot. According to the PICMG 2.0 R3.0 standard and referring now to FIG. 9, the host card in system slot 920a has to provide the following functionality to support the other cards (e.g., I/O cards) in the peripheral slots 920b-920c.

The Host Card/Slot Requirements:

Driving CPCI Clocks radially to all the peripheral (I/O) slots 920b-920c in the segment 910.

Handling PCI arbitration.

Handling PCI Interrupts.

Handling Hotswap (ENUM Interrupt) activities of I/O card.

The PICMG 2.0 R3.0 compliant I/O card which is present in any of the PICMG 2.0 R3.0 compliant slots 920a-920c will need and expect the PCI clocks from the host card in the system slot 920a. The PICMG 2.0 R3.0 compliant I/O or node card needs a host card (PICMG 2.0 R3.0 compliant) to function properly in a PICMG 2.0 R3.0 and PICMG 2.16 R1.0 compliant backplane/system 900.

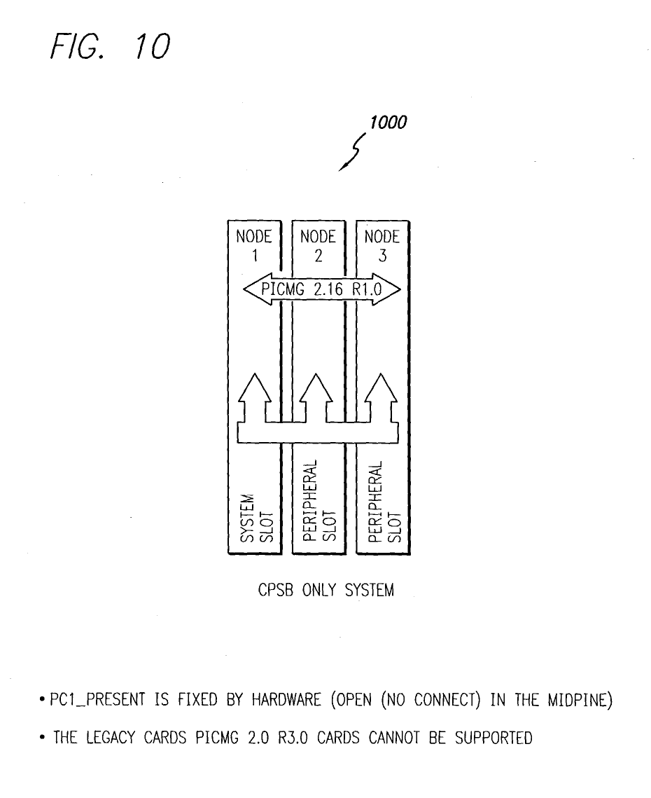

A PICMG 2.16 R1.0 backplane, by contrast, supports either CPCI and CPSB (PICMG 2.0 R3.0 and PICMG 2.16 R1.0 compliant) configuration or CPSB only (PICMG 2.16 R1.0 compliant) configuration. However, if the PICMG 2.16 R1.0 compliant backplane is configured to CPSB only and, referring now to FIG. 10, the backplane 1000 (which support the CPSB only card) will not support any previous PICMG 2.0 R3.0 cards which are widely available and used today. Thus, in order to support the legacy cards (PICMG 2.0 R3.0 cards) and, referring back to FIG. 9, the CPCI and CPSB backplane 900, which supports CPCI and CPSB cards, needs to be used. Typically, the backplane 900 has one or more segments (only one segment 910 is shown in FIG. 9) and all these segments are configured as CPCI and CPSB by hardware (i.e., PCI_PRESENT 930 is hardwired to low).

| | | | | PICMG 2.0 |
|---|---|---|---|---|
| | | | | R3.0 and |
| PCI_PRESENT | Modes | PICMG 2.0 | PICMG 2.16 | PICMG 2.16 |
| Pin | supported | R3.0 | R1.0 | R1.0 |
| GND | CPCI + | Yes* | Yes | Yes** |
| | CPSB | | | |
| OPEN (High) | CPSB | No | Yes | Yes*** |
| | Only | | | |

*Supports PICMG 2.0 R3.0 cards provided that there is a host card which is present in the system slot. This type of card cannot be used in CPSB only configuration which will cause damage to PCI device and misbehavior of the card function.
**This type of card (universal cards) can be plugged into node (I/O) slot only if the host card is present in the segment. This card cannot be used in the CPSB only configuration in the CPCI and CPSB backplanes which will cause damage to PCI device and misbehavior of the card function.
***Supports only CPSB Interface PICMG 2.16 R1.0.

The challenge presented in supporting the CPCI and CPSB system 900 is that this system 900 will require a host card in each segment 910 in order to support a universal card (PICMG 2.0 R3.0 and PICMG 2.16 R1.0 compliant) in the I/O or node slots 920a-920c. Otherwise, the universal card will be damaged (e.g., because floating clock input on the PCI device in the card will overheat the device) and misbehave.

To resolve the above-described challenge, an embodiment of the invention uses certain hardwares and removed other hardwares that were already featured in the design and provides a separate software to control the configuration of the backplane. The software may be written onto a read-only memory (ROM) associate with the microprocessor on a Chassis Management Controller (CMC) that may be already featured on the embodiment.

In one embodiment of the present invention, universal cards are supported in various configuration (e.g., host and/or no host configurations) when the backplane segments required for supporting these cards are configured by software instead of by hardware. Specifically, the embodiment includes a system that provides the facility to configure the CPCI segments by software.

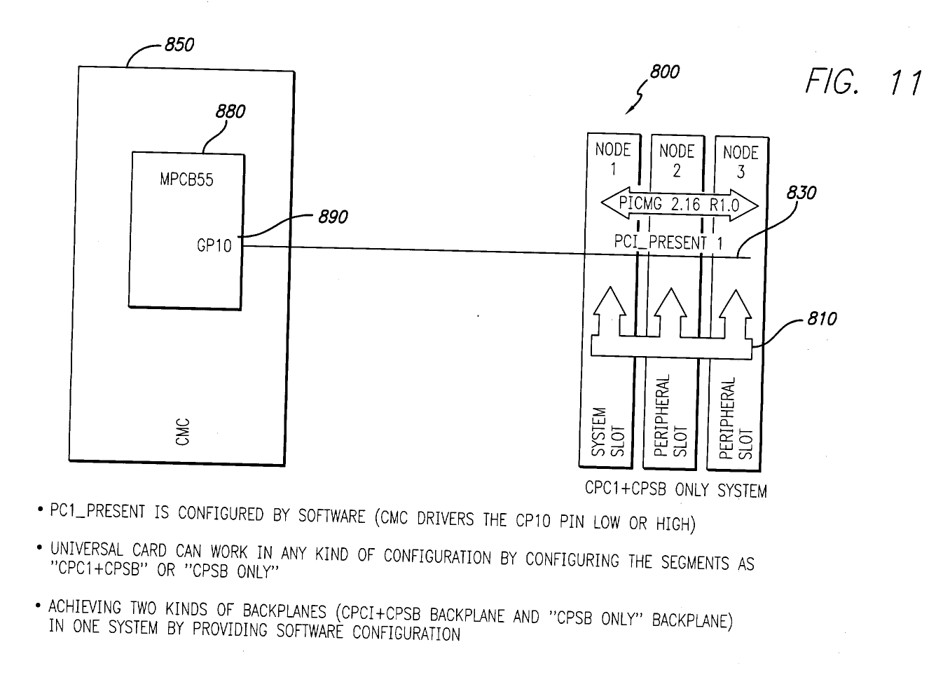

Specifically, and referring now to FIGS. 8 and 11, the PCI_PRESENT pins in each segment 810 of a present inventive embodiment is wired via a bus 830 (e.g., a corresponding Intelligent Platform Management Bus) into a CMC 850. That is, a plurality of independent bus 830a-830d from each of the segments 810a-810c are wired into the CMC 850.

In operation, the CMC 850 is initially running on standby power. Before the CMC 850 of the present invention powers ON the power supplied units (PSUs) 860 via another bus 870 (e.g., an integrated-circuit bus, I2C bus, or Intelligent Platform Management Bus), the CMC is used to configure each segment 810 to a CPCI and CPSB segment or CPSB only segment via bus 830 by pulling the pin connected to the bus 830 high or low. So, the backplane 800 of the present invention can have multiple configurations instead of just one. In one embodiment, a 0.01 uF bypass capacitance to ground output is provided to the PCI_PRESENT pin to provide an AC return path for the neighboring signal when the pin is to be pulled low. In another embodiment, a 10 uK pull-up resistance output is provided to the PCI_PRESENT pin to guarantee receivers on the card connected to the pin observe a logical one (1) when the pin is to be pulled high. In any case, the above embodiments enable a user of the backplane 800 to use the universal cards and PICMG 2.0 R1.0 cards in all the configurations (e.g., a CPCI and CPSB and/or CPSB only). Moreover, the user can now configure each segment 810 of the backplane 800 as is needed and does not have to be confined to a fixed configuration. That is, the segments 810 of the backplane 800 are variably configurable to CPCI and CPSB or CPSB only by controlling the PCI_PRESENT# signal 830. The PCI_PRESENT# signals 830 for each of the segments 810 is be controlled by the CMC 850 and the CMC software located within the CMC 850 can be used to configure the segment 810 by driving “zero” or “one” to the PCI_PRESENT# signals 830 on the segment 810, pursuant to the user's dynamic requirements. This allows the flexibility to configure the segment 810 to either a CPCI and CPSB configuration or a CPSB only configuration and provides the flexibility to support CPCI and CPSB interface cards (or boards) in a host-less and CPSB only environment.

Referring now to FIGS. 1, 8 and 11, a CPCI/PSB system of the present invention may comprise a chassis 100 having a backplane (or midplane) 102 or 800 and a power supply 120 or a plurality PSUs 860 that supplies a plurality of powers having various voltages to the backplane 102 or 800. A PICMIG compliant hotswappable front card (or motherboard) 108 may be inserted onto the backplane even when the power supply is switched on (“hot-insertion”).

Referring now to only FIGS. 8 and 11, the systems of the present invention includes a CMC 850. The CMC 850 may include a processor 890 having a general purposes input and output (GPIO) device 890 to provide the software configurable PCI_PRESENT signals. That is, the CMC 850 can drive the GPIO device 890 to produce a low (or ground) output or a high (or open) output. The low and/or high outputs are then provided as separate and independent PCI_PRESENT signals 830a-830d to each of the segments 810a-810d to configure the segments as either CPCI and CPSB or CPSB only. Thus, universal cards and legacy cards (e.g., PICMG 2.0 R3.0) can be flexibly or variably supported on the backplane 800 in the CPCI and CPSB configuration. In addition, the universal cards can be flexibly or variably supported on the same backplane 800 without a host card in the CPSB only configuration.

In general, according to the foregoing, an embodiment of the present invention provides a processor (e.g., processor 880) and a software driven on the processor to provide a variable PCI_PRESENT signal via an I/O device (e.g., GPIO 890) on the processor. In one embodiment, the software uses one or more independent electrical circuitries and/or connections to provide various PCI_PRESENT signals to each segment on the CPCI/PSB. The present invention, thus, provides a low-cost and highly flexible system that can control and change configuration on a backplane during the system's lifetime that overcomes the limitations of the prior art.

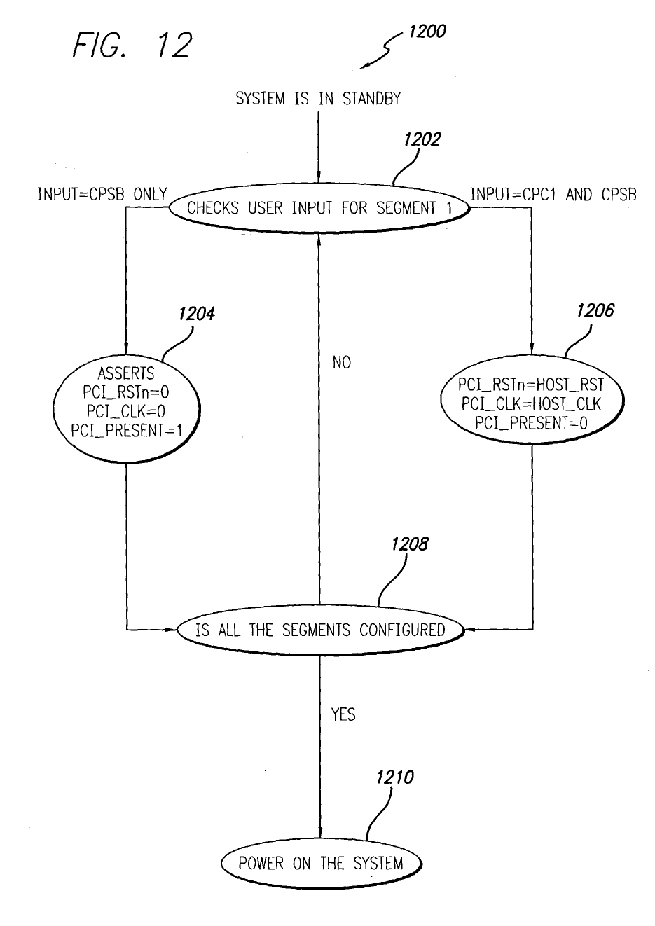

In addition, the present invention provides a method, such as exemplary method 1200 for providing software control and segment configuration for a CPCI/PSB, as diagrammed in FIG. 12. At step 1202, the method 1200 checks an user configurable input for configuring one of the segments on the backplane (i.e., CPCI/PSB). If the input is determined to be for a CPSB only configuration, the method 1200 moves to step 1204 and assets a logical zero (0) value as the PCI_RSTn signal, a logical 0 value as the PCI_CLK signal, and a logical one (1) value as the PCI_PRESENT signal to all the slots on the segment. If the input is determined to be for a CPCI and CPSB configuration, the method 1200 moves to step 1206 and assets a Host RST value as the PCI_RSTn signal, a Host_CLK value as the PCI_CLK signal, and a logical 0 value as the PCI_PRESENT signal to the segment. The method 1200 then moves to step 1208 to determine whether all the segments on the backplane have been configured. If all the segments have not been configured, step 1202 is repeated. If all the segments have been configured, the method 1200 moves to 1210 to begin a powering on process for a plurality of front cards on the backplane. The method 1200 diagrammed in FIG. 12 may include a mechanism that detects the type of front cards that is on the system before the segment configuration steps. Moreover, depending on the type of cards that is on the segment, the Method 1200 may automatically provide the input described in step 1202 or may automatically provide the segment configuration step described in steps 1204 or 1206 without any additional user interaction Thus, the method diagrammed in FIG. 12 is provided as an example by which the invention is not limited.

Having thus described embodiments of the present invention, it should be apparent to those skilled in the art that certain advantages of the described system have been achieved. It should also be appreciated that various modifications, adaptations, and alternative embodiments thereof may be made within the scope and spirit of the present invention. For example, a CPCI/PSB system, a CPCI/PSB, and a universal front card have been illustrated, but it should be apparent that the inventive concepts described above would be equally applicable to other types of buses, backplanes, cards, motherboards, and computer systems. The invention is further defined by the following claims.

What is claimed is:

1. A Compact Peripheral Component Interconnect Packet Switching Backplane (CPCI/PSB) system comprising:
a chassis;
a circuit board forming a backplane within said chassis;
a plurality of segments on said circuit board, each of said plurality segments comprising a plurality of slots for coupling to a plurality of front cards;
a Chassis Management Controller (CMC) coupled with said circuit board; and
a CMC software running on said CMC;
wherein said CMC comprises a plurality of communication links;
wherein each of said plurality of communication links is coupled to a corresponding one of said plurality of segments;
wherein said CMC software can assert first and second Compact Peripheral Component Interconnect (CPCI) signals to each of said plurality of segments via said plurality of communication links;
wherein said first CPCI signal is for configuring a first one of said plurality of segments on said circuit board as a CPCI/PSB segment; and
wherein said second CPCI signal is for configuring a second one of said plurality of segments on said circuit board as a Compact Packet Switching Backplane (CPSB) only segment.

2. The CPCI/PSB system of claim 1, further comprising:
a CPCI interface connected with said circuit board; and
an Ethernet interface, apart from said CPCI interface, connected with said circuit board.

3. The CPCI/PSB system of claim 1,
wherein said CMC comprises a microprocessor having an input and output (I/O) device;
wherein said CMC software drives said I/O device to produce first and second outputs; and
wherein said first output is provided as said first CPCI indication signal and said second output is provided as said second CPCI indication signal.

4. The CPCI/PSB system of claim 3, wherein said first output comprises a capacitance to ground output and wherein said second output comprises a pull-up resistance output.

5. The CPCI/PSB system of claim 3, wherein said CMC software is stored within a read-only memory (ROM) associated with said microprocessor, and wherein said CMC software is for running only on said microprocessor.

6. The CPCI/PSB system of claim 1, wherein said first CPCI signal configures said first one of said plurality of segments by asserting a host card reset signal, a host card clock signal, and a logical zero indication signal.

7. The CPCI/PSB system of claim 1, wherein said second CPCI signal configures said second one of said plurality of segments by asserting a logical zero reset signal, a logical zero clock signal, and a logical one indication signal.

8. The CPCI/PSB system of claim 1,
wherein said second CPCI signal configures said second one of said plurality of segments by asserting a no host card reset signal, a no host card clock signal, and a ground indication signal; and
wherein said first CPCI signal configures said first one of said plurality of segments by asserting a host card reset signal, a host card clock signal, and an open indication signal.

9. The CPCI/PSB system of claim 1,
wherein said first CPCI signal configures any front card coupled to said first one of said plurality of segments to require a host card; and
wherein said second CPCI signal configures any front card coupled to said second one of said plurality of segments to function as a host-less front card.

10. The CPCI/PSB system of claim 1, wherein each of said segments on said circuit board can variably support a legacy card, a universal card configured to require a host card, and a universal card configured to operate without a host card.

11. The CPCI/PSB system of claim 1, wherein each of said segments on said circuit board can variable support a CPCI legacy card, a PS host-less card, and a CPCI/PSB card.

12. The CPCI/PSB system of claim 1, wherein said circuit board forming said backplane can support a PCI Industrial Computer Manufacturers Group (PICMG) 2.0 R3.0 compliant front card, a PICMG 2.16 R1.0 compliant front card, and a PICMG 2.0 R3.0 and PICMG 2.16 R1.0 compliant front card.

13. The CPCI/PSB system of claim 1, wherein said CMC asserts said first and second CPCI signals before powering on the system.

14. The CPCI/PSB system of claim 13, wherein said CMC software independently asserts a CPCI signal comprising one of said first CPCI signal and said second CPCI signal to each of said segments on said circuit board via said plurality of communication links.

15. The CPCI/PSB system of claim 14, wherein said CMC software allows a user to variably select whether to configure each of segments as a CPCI/PSB segment or a CPSB only segment.

16. The CPCI/PSB system of claim 1, wherein a host card on said CPCI/PSB segment drives a CPCI clock to each of said plurality of slots on said CPCI/PSB segment.

17. The CPCI/PSB system of claim 15, wherein said host card further handles a PCI arbitration for a plurality of slots on said CPCI/PSB segment, a PCI interrupt for said plurality of slots on said CPCI/PSB segment, and a Hotswap activity for a front card coupled to at least one of said plurality of slots on said CPCI/PSB segment.

18. The CPCI/PSB system of claim 1, wherein a hardwired mechanism for configuring said plurality of segments is eliminated on said circuit board.

19. A method for implementing configurations on a Compact Peripheral Component Interconnect Packet Switching Backplane (CPCI/PSB) within a chassis, comprising:
coupling a Chassis Management Controller (CMC) to a plurality of segments on said CPCI/PSB through a plurality of communications links;
checking an input provided via a CMC software running on said CMC;
asserting via said CMC software a logical zero reset signal, a logical zero clock signal, and a ground indication signal to one of said plurality of segments if said input indicates a CPCI/PSB configuration;
asserting via said CMC software a host card reset signal, a host card clock signal, and an open indication signal to one of said plurality of segments if said input indicates a Compact Packet Switching Backplane (CPSB) only configuration;
checking via said CMC software if all of said plurality of segments on said CPCI/PSB have been configured; and
powering on a plurality of front cards on said CPCI/PSB.

20. The method of claim 19, wherein each of said segments on said CPCI/PSB first has to be configured via said CMC software before powering on a plurality of front cards on said CPCI/PSB.

21. The method of claim 20, wherein each of said plurality of communication links is independently coupled to a corresponding one of said plurality of segments.

22. A Compact Peripheral Component Interconnect Packet Switching Backplane (CPCI/PSB) system comprising:
a chassis;
a power supply unit (PSU);
a circuit board forming a backplane within said chassis;
first and second segments on said circuit board, each of said first and second segments comprising a plurality of slots for coupling to a plurality of front cards;
a Chassis Management Controller (CMC) coupled with said circuit board; and
a CMC software running on said CMC;
wherein said CMC comprises first, second, and third independent communication links;
wherein said first independent communication link is coupled to said first segment;
wherein said second independent communication link is coupled to said second segment;
wherein said third independent communication link is coupled to said PSU;
wherein said CMC software can assert first and second configuration signals to each of said first and second segments via said first and second communication links; and
wherein each of said segments on said circuit board can variably support a CPCI legacy card, a CPCI/PSB card configured to require a host card, and a CPCI/PSB card configured to operate without a host card.

23. The CPCI/PSB system of claim 22, wherein said CMC asserts said first and second configuration signals before sending a third configuration signal via said third independent communication link to power on said PSU.

24. The CPCI/PSB system of claim 23,
wherein said first configuration signal configures any front card coupled to said first segment to require a host card; and
wherein said second configuration signal configures any front card coupled to said second segment to function as a host-less front card.

25. The CPCI/PSB system of claim 24, wherein said circuit board forming said backplane can support a PCI Industrial Computer Manufacturers Group (PICMG) 2.0 R3.0 compliant front card, a PICMG 2.16 R1.0 compliant front card, and a PICMG 2.0 R3.0 and PICMG 2.16 R1.0 compliant front card.
